(19) United States
(12) Patent Application Publication
(10) Pub. No.: US 2023/0275441 A1
(43) Pub. Date: Aug. 31, 2023

(54) BATTERY PROTECTION CIRCUIT, BATTERY PACK AND ELECTRONIC DEVICE

(71) Applicant: XI'AN WENXIAN SEMICONDUCTOR TECHNOLOGY CO. LTD, Xi'an (CN)

(72) Inventors: Lijun SONG, Xi'an (CN); Pengliang SONG, Xi'an (CN)

(73) Assignee: XI'AN WENXIAN SEMICONDUCTOR TECHNOLOGY CO. LTD, Xi'an (CN)

(21) Appl. No.: 18/110,149

(22) Filed: Feb. 15, 2023

Related U.S. Application Data
(63) Continuation-in-part of application No. PCT/CN2021/115169, filed on Aug. 27, 2021.

(30) Foreign Application Priority Data
Aug. 27, 2020 (CN) 202010881223.9

(51) Int. Cl. H02J 7/00

(52) U.S. Cl. CPC H02J 7/0029; H02J 7/0047; H02J 7/00711

(57) ABSTRACT

A battery protection circuit, which includes: a power supply terminal, a power ground terminal, an overcharge voltage protection sub-circuit, an over-discharge voltage protection sub-circuit, a discharge over-current protection sub-circuit, a reference voltage generation sub-circuit, a frequency generation sub-circuit, a controller and a first switch sub-circuit. The battery protection circuit further includes a shipping input terminal, the battery protection circuit is configured to enter a shipping mode when a first signal is received at the shipping input terminal, and in the shipping mode, at least one sub-circuit of the battery protection circuit is powered off. The present application also provides a battery pack and an electronic device, advantages of the present application include that the current consumption of the battery during transportation and storage can be reduced, and the power retention time of the battery can be increased, so that the user’s experience can be improved.

### CROSS-REFERENCE TO RELATED APPLICATIONS

This application is a continuation-in-part of International Application No. PCT/CN2021/115169, filed on Aug. 27, 2021, which claims the benefit of Chinese Patent Application No. 202010881223.9, filed on Aug. 27, 2020, the entire contents of which are incorporated herein by reference.

### BACKGROUND

### 1. Technical Field

The present application relates to the field of battery technology, and in particular, to a battery protection circuit, a battery pack and an electronic device.

### 2. Description of Related Art

Battery packs are widely used in electronic devices, such as true wireless stereo (TWS) headsets, cell phones, tablet PCs, etc., to provide a more flexible environment for the use of the electronic devices without being limited to the range of outlets and power supply cables. In general, a battery pack includes a bare battery and a battery protection circuit that is electrically connected to the bare battery to prevent the bare battery from being overcharged or over-discharged.

After the electronic device equipped with battery pack is manufactured at the production place, the battery pack is charged with a preset amount of power and then the electronic device is turned off, after that, the electronic device will be transported and stored for a long period of time. Thus, when the electric device is finally received and operated by an end user for the first time, the electronic device may be completely discharged due to internal current consumption for the long-term transportation and storage. Therefore, the end user must recharge the electronic device before the first use to restore the power, resulting in a poor user experience.

### SUMMARY

One objective of embodiments of the present application is to provide a battery protection circuit, a battery pack and an electronic device, aiming at reducing a current consumption of a battery during the transportation and storage, increasing the battery’s power retention time, and improving the user’s experience.

To achieve the above objective, a first aspect of the embodiments of the present application provides a battery protection circuit, which includes: a power supply terminal, a power ground terminal, an overcharge voltage protection sub-circuit, an over-discharge voltage protection sub-circuit, a discharge over-current protection sub-circuit, a reference voltage generation sub-circuit, a frequency generation sub-circuit, a controller and a first switch sub-circuit. The power supply terminal and power ground terminal are respectively configured to be electrically connected to a battery. The first switch sub-circuit is configured to control the battery power supply to a system circuit. The battery protection circuit also includes a shipping input terminal, the battery protection circuit is configured to enter a shipping mode when a first signal is received at the shipping input terminal, and at least one sub-circuit of the battery protection circuit is powered off in the shipping mode.

Optionally, the first switch sub-circuit is switched off in the shipping mode to enable the battery to stop supplying power to the system circuit.

Optionally, the battery protection circuit also includes a wake-up sub-circuit, the wake-up sub-circuit is powered on in the shipping mode, and the wake-up sub-circuit is configured to enable the battery protection circuit to exit the shipping mode.

Optionally, the battery protection circuit is triggered to generate a shipping control signal to enter the shipping mode when the first signal is received at the shipping input terminal.

Optionally, the first signal is a coded signal based on a protocol between the battery protection circuit and the system circuit.

Optionally, the first signal includes a pulse signal, the battery protection circuit also includes a pulse counting sub-circuit, the pulse counting sub-circuit is in electrical connection with the shipping input terminal, and a generation of the shipping control signal is triggered when the number of pulses received by the pulse counting sub-circuit within a first predetermined time period is greater than or equal to a first predetermined number.

Optionally, the first signal includes a continuous high-level signal or a continuous low-level signal, the battery protection circuit also includes a first timing sub-circuit, the first timing sub-circuit is in electrical connection with the shipping input terminal, a generation of the shipping control signal is triggered when a duration of the high-level signal or the low-level signal received by the first timing sub-circuit is greater than or equal to a second predetermined time period.

Optionally, the over-discharge voltage protection sub-circuit includes a comparator and a second timing sub-circuit. An output of the comparator is in electrical connection with the second timing sub-circuit. The first signal is a continuous high-level signal or a continuous low-level signal. The battery protection circuit also includes a second switch sub-circuit and a first resistor. A control end of the second switch sub-circuit is in electrical connection with the shipping input pin, an input of the second switch sub-circuit is grounded, an output of the second switch sub-circuit is in electrical connection with one end of the first resistor, and another end of the first resistor is connected to a high level, the output of the second switch sub-circuit is further electrically connected to an inverting terminal of the comparator of the over-discharge voltage protection sub-circuit. An output of the comparator is in electrical connection with a second timing sub-circuit, the second switch sub-circuit is switched on when the first signal is received at the shipping input terminal, a generation of the shipping control signal is triggered when a duration of high level received by the second timing sub-circuit is greater than or equal to a third predetermined time period.

Optionally, the wake-up sub-circuit is the charge detection sub-circuit.

Optionally, the battery protection circuit is enabled to exit the shipping mode when a charging signal is detected by the charge detection sub-circuit.

Optionally, at least one of the overcharge voltage protection sub-circuit, the over-discharge voltage protection sub-circuit, the discharge over-current protection sub-circuit, the controller, the reference voltage generation sub-circuit and the frequency generation sub-circuit is powered off in the shipping mode.

Optionally, all sub-circuits of the battery protection circuit except for the wake-up sub-circuit are powered off when the battery protection circuit is in the shipping mode.

Optionally, the first switch sub-circuit includes a MOS transistor.

Optionally, the battery protection circuit is fabricated on a same chip, or alternatively, all sub-circuits of the battery protection circuit except for the first switch sub-circuit are fabricated on the same chip.

A second aspect of the embodiments of the present application provides a battery pack, including: a battery, and the battery protection circuit as described above, where the power supply terminal, and power ground terminal of the battery protection circuit are electrically connected to the battery, respectively.

Optionally, the battery has a capacity in a range from 10 mAH to 80 mAH.

A third aspect of the embodiments of the present application provides an electronic device, including: the battery pack as described above and a system circuit, wherein the battery is controlled to supply power to the system circuit via the battery protection circuit.

Optionally, the electronic device is a TWS headset.

Beneficial effects of the embodiments of the present application are that: the shipping input terminal is further included in the battery protection circuit, the battery protection circuit is configured to enter the shipping mode when the first signal is received at the shipping input terminal, and one or more sub-circuits of the battery protection circuit are powered off in the shipping mode. Since the one or more sub-circuits of the battery protection circuit are powered off in the shipping mode, the power consumption of the battery can be reduced, then the current consumption of the electronic device can be reduced, which thus can increase the power retention time of the battery. When the user gets hold of the electronic device, the user only needs to operate the wake-up sub-circuit to enable the battery protection circuit to exit the shipping mode, then the electronic device, when turned on, can be used normally, so that the user’s experience is improved.

### BRIEF DESCRIPTION OF THE DRAWINGS

To illustrate solutions in the embodiments of the present application more clearly, the following will briefly introduce the drawings that need to be used in the description of the embodiments. It is obvious that the drawings in the following description are merely some examples of the present application, and for a person of ordinary skill in the art, other drawings may also be obtained on basis of these drawings without paying any creative efforts.

FIG. 1 is a schematic diagram of a circuit module of an electronic device in accordance with an embodiment of the present application.

FIG. 2 is a waveform diagram for a signal received at a shipping input terminal and an output signal of a pulse counting sub-circuit, shown in FIG. 1.

FIG. 3 is a schematic diagram of the circuit module of the electronic device in accordance with another embodiment of the present application.

FIG. 4 is a schematic diagram of the circuit module of the electronic device in accordance with yet another embodiment of the present application.

FIG. 5 is a waveform diagram of the signal received at the shipping input terminal and an output signal of a first timing sub-circuit, shown in FIG. 4.

FIG. 6 is a schematic diagram of the circuit module of the electronic device in accordance with a further embodiment of the present application.

FIG. 7 is a diagram of a specific circuit implementation of the shipping input terminal and an over-discharge voltage protection sub-circuit in accordance with an embodiment of the present application.

FIG. 8 is a waveform diagram of the signal received at the shipping input terminal and an output signal of a second timing sub-circuit, shown in FIG. 7.

### DETAILED DESCRIPTION

To make the solutions in the embodiments of the present application clearer and more comprehensible, the embodiments of the present application will be further described in conjunction with the drawings. Obviously, the embodiments described in here are only part of the embodiments of the present application, not all of them. Other embodiments obtained by a person of ordinary skill in the art based on these embodiments on the premise of paying no creative labors shall all fall within the protection scope of the present application.

The terms “include” and “have” and any variations thereof appearing in the specification, claims, and drawings of the present application are intended to cover non-exclusive inclusion. For example, a process, a method, a system, a product, or an apparatus includes a series of steps or modules is not limited to the listed steps or units, but optionally also includes steps or units not listed, or optionally also includes other steps or units inherent to the process, the method, the product, or the apparatus. In addition, the terms “first”, “second”, “third”, etc. are used to distinguish between different objects rather than to describe a particular order.

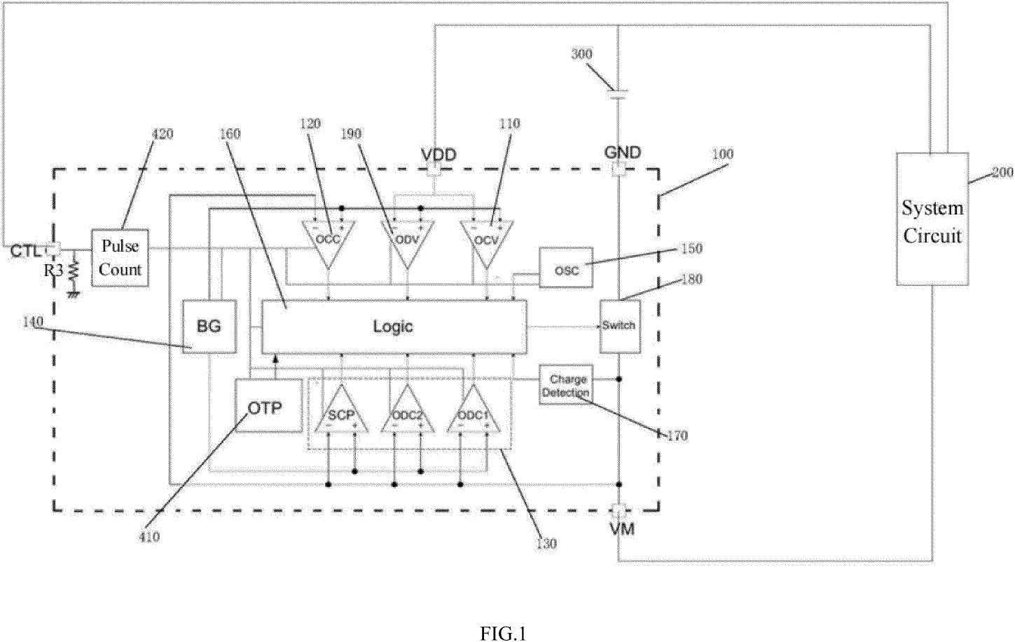

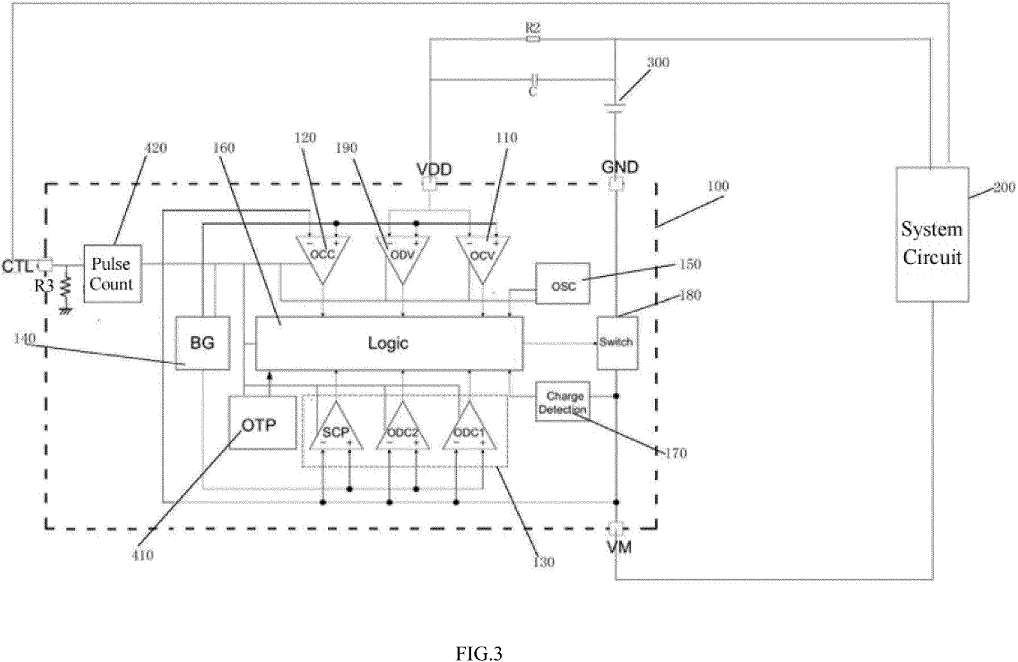

An embodiment of the present application provides an electronic device, which may be such as a TWS headset, a cell phone, a tablet computer, etc. Referring to FIG. 1, the electronic device includes a battery pack and a system circuit 200. The system circuit 200 is, for example, a circuit consisting of a microprocessor, a camera drive circuit, an image processor, etc. The system circuit 200 is electrically connected to the battery pack, and the battery pack is configured to supply power to the system circuit 200. The battery pack includes a battery 300 and a battery protection circuit 100. The battery protection circuit 100 is electrically connected to positive and negative poles of the battery 300. The system circuit 200 is electrically connected to the battery protection circuit 100, the battery 300 supplies power to the battery protection circuit 100, and the battery protection circuit 100 plays a role of protection, for example, when the battery 300 is overcharged or over-discharged. How the battery 300 is protected by the battery protection circuit 100 when being overcharged or over-discharged are common technical means in this field, which will not be repeated here. In this embodiment, the number of batteries 300 is one or more, when multiple batteries 300 are provided, the multiple batteries 300 may be connected in parallel or in series or mixed in series and parallel. Optionally, the battery 300 is a lithium battery, a capacity of the battery 300 is in a range from 10 mAH to 80 mAH, for example, 10 mAH, 20 mAH, 30 mAH, 40 mAH, 50 mAH, 60 mAH, 70 mAH, 80 mAH, the battery 300 having a capacity in this range is in a smaller size, and optionally, the capacity of the battery 300 is in a range from 20 mAH to 40 mAH, in this case, the size of the battery 300 is much more smaller, which thus can be easily configured in small electronic devices, for example, a TWS headset. Moreover, since the capacity of the battery 300 is so small, how to maintain the power of the battery 300 for a long time becomes a very important subject. In other embodiments, referring to FIG. 3, a second resistor R2 and a capacitor C are provided between the battery 300 and the battery protection circuit 100, and the second resistor R2 and the capacitor C are arranged for filtering. Alternatively, in other embodiments, other circuits or electronic components may be provided between the battery 300 and the battery protection circuit 100.

In this embodiment, still referring to FIG. 1, the battery protection circuit 100 includes a power supply terminal VDD, a power ground terminal GND, an overcharge voltage protection sub-circuit 110, an over-discharge voltage protection sub-circuit 190, a discharge over-current protection sub-circuit 130, a reference voltage generation sub-circuit 140, a frequency generation sub-circuit 150, a controller 160, a charge detection sub-circuit, and a first switch sub-circuit 180.

In this embodiment, the power supply terminal VDD and the power ground terminal GND are configured to be electrically connect to the positive and negative poles of the battery 300 respectively, so that the battery 300 can supply power to the battery protection circuit 100, and meanwhile, a loop is formed by the battery 300 via the battery protection circuit 100 and the system circuit 200, to supply power to the system circuit 200.

In this embodiment, the overcharge voltage protection sub-circuit 110 is configured to protect the battery 300 when a charging voltage is detected to be too high during a charging process of the battery 300, such as the battery 300 is controlled to stop being charged, etc., to prevent the battery 300 from being damaged or having safety problems.

In this embodiment, the over-discharge voltage protection sub-circuit 190 is configured to protect the battery 300 when a discharge voltage is detected to be too low during a discharge process of the battery 300, such as the battery 300 is controlled to discharge only to a minimum level, etc., and generally, the power supply to the system circuit 200 is stopped and the power supply to sub-circuits of the battery protection circuit 100 except for the charge detection sub-circuit is also stopped, to prevent the battery 300 from being over-discharged and causing permanent damage to the battery 300.

In this embodiment, the discharge over-current protection sub-circuit 130 is configured to protect the battery 300 when an excessive discharge current is detected during the discharge process of the battery 300, for example, the battery 300 is controlled to stop discharging, etc., to prevent permanent damage to the battery 300 or safety problems caused by the excessive discharge current. In this embodiment, the discharge over-current protection sub-circuit 130 includes multiple sub-circuits, each of which is electrically connected to the controller 160, and each sub-circuit is configured to process a different discharge current, and in an embodiment, three sub-circuit are provided as shown in FIG. 1.

In this embodiment, the reference voltage generation sub-circuit 140 is configured to generate a reference voltage required for the battery protection circuit 100, the frequency generation sub-circuit 150 is configured to generate different frequencies, and the controller 160 is electrically connected to the overcharge voltage protection sub-circuit 110, the over-discharge voltage protection sub-circuit 190, the discharge over-current protection sub-circuit 130, the reference voltage generation sub-circuit 140, the frequency generation sub-circuit 150, the wake-up sub-circuit 170, the first switch sub-circuit 180, etc., respectively. In this embodiment, the overcharge voltage protection sub-circuit 110, the over-discharge voltage protection sub-circuit 190, the discharge over-current protection sub-circuit 130, the reference voltage generation sub-circuit 140, the frequency generation sub-circuit 150, and the controller 160 are conventional circuits in this field, which will not be further described in here.

In this embodiment, the charge detection sub-circuit is configured to detect whether the electronic device is connected to a power supply through a charger for charging the battery 300, and after the electronic device is connected to the power supply through the charger, a charging signal is detected by the charge detection sub-circuit to charge the battery 300. In case that the battery 300 is protected due to the over-discharge voltage protection sub-circuit 190, then the over-discharge voltage protection to the battery 300 is withdrawn when the charging signal is detected by the charge detection sub-circuit detect, that is, the system circuit 200 and the battery protection circuit 100 will be powered normally.

In this embodiment, the first switch sub-circuit 180 includes a switch and a substrate control circuitry. The switch is a MOS transistor, a control end of the switch is electrically connected to the controller 160, the substrate control circuitry is electrically connected to the controller 160, and the substrate control circuitry is configured to achieve a correct bias of a substrate of the switch. However, the present application is not limited to this, in other embodiments, the first switch sub-circuit 180 may also include a charging switch and a discharging switch, where the charging switch and the discharging switch are both MOS transistors, and the charging switch and the discharging switch are electrically connected to the controller 160, respectively. Alternatively, in other embodiments, the first switch sub-circuit 180 may also be provided in other forms, for example, including only one switch. In this embodiment, the first switch sub-circuit 180 is configured to control the battery 300 to supply power to the system circuit 200, specifically, the power is supplied to the battery protection circuit 100 through a loop formed via the battery 300, the system circuit 200, and the first switch sub-circuit 180 of the battery protection circuit 100. Exemplarily, a control end of the first switch sub-circuit 180 is electrically connected to the controller 160, and an input of the first switch sub-circuit 180 is electrically connected to the battery 300, for example, to the power ground terminal GND of the battery protection circuit 100, and an output of the first switch sub-circuit 180 is electrically connected to the system circuit 200, so that a power-supply loop is formed via the battery 300, the battery protection circuit 100, and the first switch sub-circuit 180, and thus whether the battery 300 supplies power to the system circuit 200 or not can be controlled by the battery protection circuit 100 by controlling the first switch sub-circuit 180.

In this embodiment, the battery protection circuit 100 also includes a shipping input terminal CTL, and the shipping input terminal CTL is a terminal newly added for the battery protection circuit 100. The battery protection circuit 100 may enter the shipping mode when a first signal is received at the shipping input terminal CTL, and one or more sub-circuits of the battery protection circuit 100 are powered off in the shipping mode. Thus, power consumption of the battery is reduced, and then current consumption of the electronic device can be reduced, and power retention time of the battery can be increased. When the user gets hold of the electronic device, the user only needs to perform an operation on the wake-up sub-circuit to enable the battery protection circuit exit the shipping mode, and the electronic device, when turned on, can be used normally, which improves the user’s experience. In this embodiment, the generation of the first signal may be realized by software or by hardware, in case that the generation of the first signal is realized by hardware, then the generation of the first signal may be realized by, for example, a power button or a sound button of the electronic device, for example, by a long pressing of the power button.

To further reduce current consumption, in this embodiment, the first switch sub-circuit 180 is disconnected in the shipping mode to stop the battery 300 from supplying power to the system circuit 200. In the shipping mode, the first switch sub-circuit is disconnected so that the battery cannot supply power to the system circuit, allowing for significant savings in battery power.

In this embodiment, the battery protection circuit 100 also includes a wake-up sub-circuit 170. The wake-up sub-circuit 170 is powered by the battery 300 in the shipping mode, and the wake-up sub-circuit 170 is configured to enable the battery protection circuit 100 to exit the shipping mode. In this embodiment, the wake-up sub-circuit 170 is the charge detection sub-circuit, and the charge detection sub-circuit is a circuit originally available in the battery protection circuit 100, so this design can save cost. In this embodiment, when the electronic device is charged, at this time, the charging signal is detected by the charge detection sub-circuit and the battery protection circuit 100 is enabled to automatically exit the shipping mode. Since the power of the battery 300 can be maintained for a long time, then the electronic device can be turned on and used normally. Alternatively, in other embodiments, the wake-up sub-circuit 170 may not be the charge detection sub-circuit, but may also be other newly-added hardware circuits specifically designed to enable the battery protection circuit 100 to exit the shipping mode, and a circuit design may be performed by a person skilled in the art according to actual needs. Alternatively, in other embodiments, the wake-up sub-circuit 170 may also be the controller 160.

In this embodiment, in case that the electronic device needs to be transported over a long distance or stored for a long time, then the battery protection circuit 100 of the electronic device will enter the shipping mode. In the shipping mode, the first switch sub-circuit 180 is disconnected, so that the battery 300 cannot supply power to the system circuit 200, which can greatly save the power of the battery 300, and in the shipping mode, the power supply to one or more sub-circuits of the battery protection circuit 100 is stopped, the battery 300 only needs to supply power to a few sub-circuits such as the wake-up circuit of the battery protection circuit 100, thus the power consumption of the battery 300 is further reduced, and then the current consumption of the electronic device can be reduced, and the current consumption can be as low as a few nA/h, so that the power retention time of the battery 300 can be increased, even when the battery 300 itself has a relatively small capacity, the power of the battery 300 can be maintained for six months to a year in the shipping mode. When the user gets hold of the electronic device, the user only needs to perform an operation on the wake-up sub-circuit 170 to enable the battery protection circuit 100 to exit the shipping mode, and then the electronic device, when turned on, can be used normally, which improves the user’s experience and prevents the user from mistakenly thinking that the electronic device is faulty.

In this embodiment, one or more of the sub-circuits of the battery protection circuit 100 are powered off in the shipping mode. In this embodiment, at least one of the overcharge voltage protection sub-circuit 110, the over-discharge voltage protection sub-circuit 190, the discharge over-current protection sub-circuit 130, the controller 160, the reference voltage generation sub-circuit 140 and the frequency generation sub-circuit 150 of the battery protection circuit 100 is powered off. In an exemplary embodiment, one of the overcharge voltage protection sub-circuit 110, the over-discharge voltage protection sub-circuit 190, the discharge over-current protection sub-circuit 130, the controller 160, the reference voltage generation sub-circuit 140 and the frequency generation sub-circuit 150 is powered off in the shipping mode. Or alternatively, two of the overcharge voltage protection sub-circuit 110, the over-discharge voltage protection sub-circuit 190, the discharge over-current protection sub-circuit 130, the controller 160, the reference voltage generation sub-circuit 140 and the frequency generation sub-circuit 150 are powered off in the shipping mode. Or alternatively, three of the overcharge voltage protection sub-circuit 110, the over-discharge voltage protection sub-circuit 190, the discharge over-current protection sub-circuit 130, the controller 160, the reference voltage generation sub-circuit 140 and the frequency generation sub-circuit 150 are powered off in the shipping mode, ..., or alternatively, the overcharge voltage protection sub-circuit 110, the over-discharge voltage protection sub-circuit 190, the discharge over-current protection sub-circuit 130, the controller 160, the reference voltage generation sub-circuit 140 and the frequency generation sub-circuit 150 are all powered off in the shipping mode, in this case, the power consumption of battery 300 can be further reduced. In addition, in other embodiments, the battery protection circuit 100 also includes a temperature protection sub-circuit 410, a charge over-current protection sub-circuit 120, etc. The temperature protection sub-circuit 410 and the charge over-current protection sub-circuit 120 may be powered on or powered off in the shipping mode, which shall also fall within the protection scope of the present invention. In this embodiment, the sub-circuits of the battery protection circuit 100 excluding the wake-up sub-circuit 170 are stopped being powered when the battery protection circuit 100 is in the shipping mode. That is, except for the wake-up sub-circuit 170 that is configured to enable the battery protection circuit 100 to exit the shipping mode, all other sub-circuits of the battery protection circuit 100 are not powered, which can further save the power of the battery 300, reduce the power consumption of the battery 300. Then, the power retention time of the battery 300 can be increased, especially the power retention time of the small capacity battery 300 can be increased.

In this embodiment, the battery protection circuit 100 is triggered to generate a shipping control signal to enter the shipping mode when the first signal is received at the shipping input terminal CTL. However, the present application is not limited to this, in other embodiments, the battery protection circuit 100 may directly enter the shipping mode when the first signal is received at the shipping input terminal CTL.

In this embodiment, the first signal is a digitally coded signal, that is, a coded signal based on the protocol pre-agreed between the battery protection circuit 100 and the system circuit at the time of design. The shipping control signal is generated by the battery protection circuit 100 to enter the shipping mode when the coded signal is received at the shipping input terminal CTL. For example, the first signal includes two time periods: a first time period for a high-level signal and a second time period for a predetermined number of pulses, where the high-level signal is used to trigger a corresponding component of the battery protection circuit 100 to be activated, e.g., to activate the corresponding component of the battery protection circuit 100 to prepare for timing or counting, and subsequently, the corresponding component of the battery protection circuit 100 is controlled to perform a counting or timing on the received pulse signal (for example, different pulses have different durations). The shipping control signal is generated by the battery protection circuit 100 when the number of pulses meets a preset requirement; and when the number of pulses does not meet the preset requirement, the corresponding component of the battery protection circuit 100 returns to an original state where no activation is performed. Since the first signal is a coded signal pre-agreed by the battery protection circuit 100 and the system circuit, the specific form of the first signal is not limited in here. The first signal may be complexly coded or simply coded that can be identified by the battery protection circuit 100 based on the protocol pre-agreed between the battery protection circuit 100 and the system circuit. In addition, the battery protection circuit 100 is reliable and safe when the first signal is in a more complex coding, which thus can prevent false triggering.

In this embodiment, three ways are provided to trigger the battery protection circuit 100 to generate the shipping control signal when the first signal is received at the shipping input terminal CTL, as described below. It should be noted that the way to trigger the battery protection circuit 100 to generate the shipping control signal when the first signal is received at the shipping input terminal CTL is not limited to the following three ways, in other embodiments of the present application, other conventional circuits may also be arranged by persons skilled in the art to trigger the battery protection circuit 100 to generate the shipping control signal.

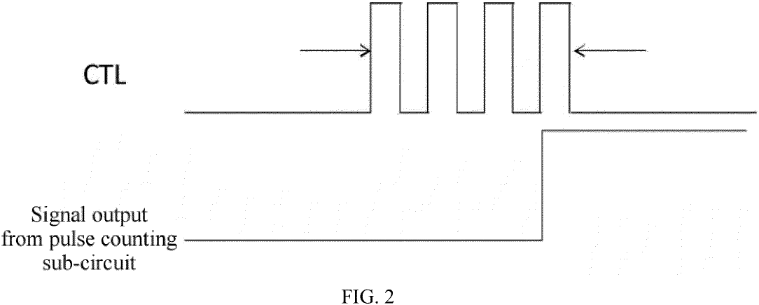

1. In an embodiment of the present application, referring to FIG. 1 and FIG. 2, the first signal includes a pulse signal, and the battery protection circuit 100 also includes a pulse counting sub-circuit 420, a third resistor R3. Here, the shipping input terminal CTL is at a low level by default, and in this embodiment, the shipping input terminal CTL is grounded via the third resistor R3 to achieve the low level, and in general conditions, a low-level signal is output from the pulse counting sub-circuit 420. The shipping input terminal CTL is electrically connected to the pulse counting sub-circuit 420. When the first signal is received at the shipping input terminal CTL, the pulse counting sub-circuit 420 is configured to perform a counting on pulses, and the pulse counting sub-circuit 420 is triggered to count at a rising edge. The signal output from the pulse counting sub-circuit 420 is switched from a low level to a high level when the number of pulses received by the pulse counting sub-circuit 420 within a first predetermined time period is greater than or equal to a first predetermined number, at this time, the high-level signal is the shipping control signal. The first predetermined time period and the first predetermined number are pre-set by the battery protection circuit 100. The first predetermined time period is, for example, a time period of 10 seconds, 5 seconds, 3 seconds, 1 second, etc., and the first predetermined number is, for example, 3, 4, 5, etc., such a design can prevent false triggering. In this embodiment, an output of the pulse counting sub-circuit 420 is electrically connected to the overcharge voltage protection sub-circuit 110, the over-discharge voltage protection sub-circuit 190, the discharge over-current protection sub-circuit 130, the reference voltage generation sub-circuit 140, the frequency generation sub-circuit 150, the controller 160, and other sub-circuits that need to be blocked from being powered, respectively, for stopping the power supply to the sub-circuits of the battery protection circuit 100 except for the wake-up sub-circuit 170. In addition, in other embodiments, a high-level signal is output from the pulse counting sub-circuit 420 in general conditions, and in this case the shipping control signal is a low-level signal. In this embodiment, the pulse counting sub-circuit 420 and the controller 160 are separately provided. Alternatively, in other embodiments, the pulse counting sub-circuit 420 may also be integrated into the controller 160.

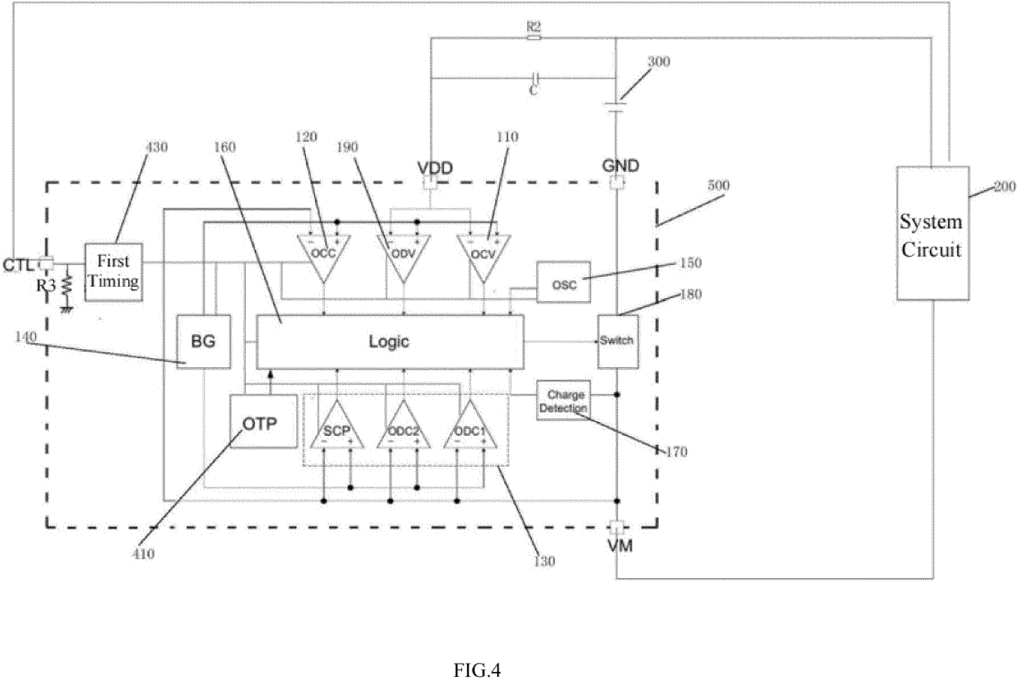

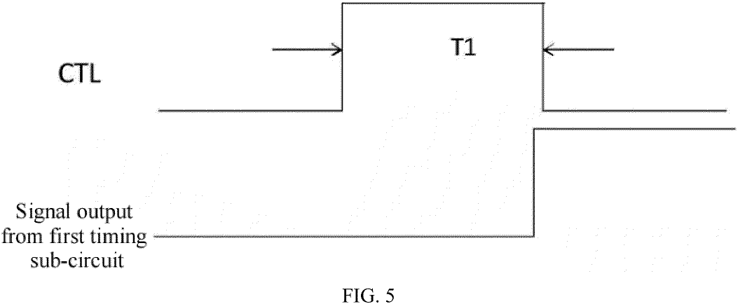

2. In another embodiment of the present application, referring to FIG. 4 and FIG. 5, the first signal includes a continuous high-level signal or a continuous low-level signal, and the battery protection circuit 500 also includes a first timing sub-circuit 430, a third resistor R3. Here, the shipping input terminal CTL is at a low level by default, and in this embodiment, the shipping input terminal CTL is grounded via the third resistor R3 to achieve the low level, and in general conditions, a low-level signal is output from the first timing sub-circuit 430, and the shipping input terminal CTL is electrically connected to the first timing sub-circuit 430. When the first signal received at the shipping input terminal CTL is a high-level signal, that is, when the signal received at the shipping input terminal CTL is switched from a low level to a high level, the first timing sub-circuit 430 is triggered to perform a timing, and the timing is triggered by the first timing sub-circuit 430 at a rising edge. The signal output from the first timing sub-circuit 430 is switched from a low level to a high level when a duration of the high-level signal received by the first timing sub-circuit 430 is greater than or equal to a second predetermined time period T1, at this time the high-level signal is the shipping control signal. The second predetermined time period T1 is pre-set by battery protection circuit 500, the second predetermined time period T1 is, for example, a time period of 10 seconds, 5 seconds, 3 seconds, 1 second, etc., such a design can prevent false triggering. In this embodiment, an output of the first timing sub-circuit 430 is electrically connected to the overcharge voltage protection sub-circuit 110, the over-discharge voltage protection sub-circuit 190, the discharge over-current protection sub-circuit 130, the reference voltage generation sub-circuit 140, the frequency generation sub-circuit 150, the controller 160, and other sub-circuits that need to be blocked from being powered, respectively, for stopping the power supply to the sub-circuits of the battery protection circuit 500 except for the wake-up sub-circuit 170. In addition, in other embodiments, a high-level signal is output from the first timing sub-circuit 430 in general conditions, and in this case the shipping control signal is a low-level signal. In this embodiment, the first timing sub-circuit 430 and the controller 160 are separately provided. Alternatively, in other embodiments, the first timing sub-circuit 430 may also be integrated into the controller 160.

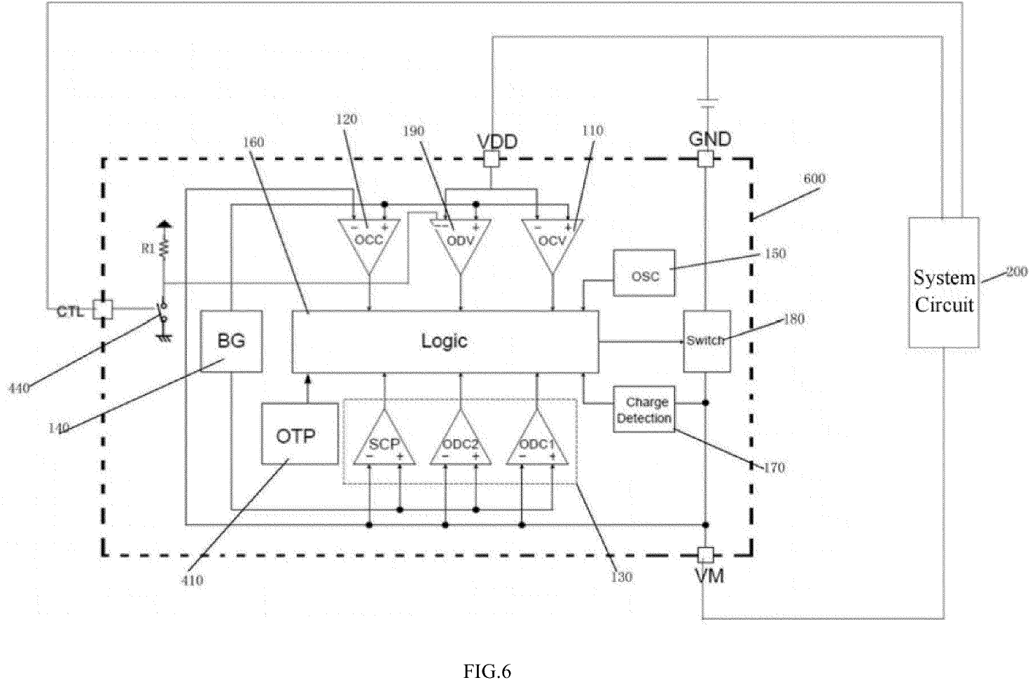

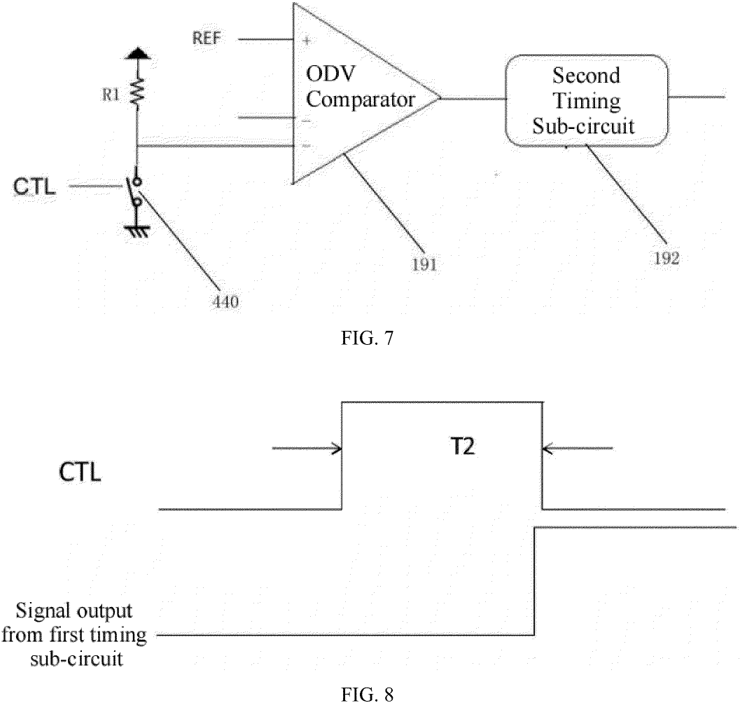

3. Generally speaking, in conventional battery protection circuits 600, when the battery 300 is deeply discharged, an over-discharged state of the battery 300 can be detected by the conventional battery protection circuit 600 or the battery protection circuit through the over-discharge voltage protection sub-circuit 190, and a signal is sent by the over-discharge voltage protection sub-circuit 190 to the controller 160. The first switch sub-circuit 180 is passively controlled to be switched off by the controller 160, and the battery protection circuit or the battery protection circuit 600 except for the charge detection sub-circuit is passively controlled to be blocked from being powered, to protect the battery 300 from damage due to excessive discharge until a charging signal is detected by the charge detection sub-circuit, then the battery protection circuit 600 is restored to be powered, where the first switch sub-circuit 180 is switched on to restore power supply to the system circuit 200. In yet another embodiment of the present application, the original circuitry and functions of the existed over-discharge voltage protection sub-circuit 190 are fully utilized to achieve active control of the first switch sub-circuit 180 to be switched off and active control of the battery protection circuit 600 except for the charge detection sub-circuit to be powered off, which can reduce costs. In an exemplary embodiment, referring to FIGS. 6-8, the over-discharge voltage protection sub-circuit 190 includes a comparator 191 and a second timing sub-circuit 192, the comparator 191 has a non-inverting terminal and two inverting terminals (i.e., a first inverting terminal and a second inverting terminal). An output of the comparator 191 is electrically connected to the second timing sub-circuit 192, the non-inverting terminal of the comparator 191 is connected with a reference voltage. The first inverting terminal of the comparator 191 is electrically connected to an output voltage detection point of the battery 300 for detecting whether the battery 300 is deeply discharged. The first signal includes a continuous high-level signal, the battery protection circuit 600 also includes a second switch sub-circuit 440 and a first resistor R1, a control end of the second switch sub-circuit 440 is electrically connected to the shipping input terminal CTL, an input of the second switch sub-circuit 440 is grounded, an output of the second switch sub-circuit 440 is electrically connected to one end of the first resistor R1, the other end of the first resistor R1 is connected to a high level. The output of the second switch sub-circuit 440 is also electrically connected to the second inverting terminal of the comparator 191 of the over-discharge voltage protection sub-circuit 190, where the first inverting terminal and the second inverting terminal have a higher priority of low level, that is, if one of the first inverting terminal or the second inverting terminal is at a low level, then the inverting terminal of the comparator 191 is at a low level. In this embodiment, the second switch sub-circuit 440 is switched on when the first signal is received at the shipping input terminal CTL, at this time the second inverting terminal of the comparator 191 is grounded, then the inverting terminal of the comparator 191 is at a low level, so that the output of the comparator 191 is at a high level. The generation of a shipping control signal is triggered when a duration of timing for the high level received by the second timing sub-circuit 192 is greater than or equal to a third predetermined time period T2, and the shipping control signal is a high-level signal. In turn, the first switch sub-circuit 180 is controlled to be switched off through the existed over-discharge voltage protection sub-circuit 190, the battery protection circuit 600 except for the charge detection sub-circuit is controlled to be blocked from being powered. The third predetermined time period T2 is pre-set by the battery protection circuit 600, and the third predetermined time period T2 is, for example, a time period of 10 seconds, 5 seconds, 3 seconds, etc., such a design can prevent false triggering. In this embodiment, the second switch sub-circuit 440 is an NMOS transistor. However, the present application is not limited to this, in other embodiments, the second switch sub-circuit 440 may also be a PMOS transistor, and then the first signal includes a continuous low-level signal.

In this embodiment, referring to FIG. 1, the battery protection circuit 100 also includes a system ground terminal VM, which is configured to electrically connect to the system circuit 200, and the system ground terminal VM is also configured for charging. In this embodiment, a first switch sub-circuit 180 is provided between the system ground terminal VM and the power ground terminal GND.

In this embodiment, the battery protection circuit 100 is fabricated on the same chip, i.e., the battery protection circuit 100 as a whole is fabricated as a system-on-chip. System on chip (SOC) is a technology commonly used in the field of integrated circuits for the purpose of combining multiple integrated circuits having specific functions on a single chip to form a system or product, in which the completed hardware system and the embedded software are contained. The system-on-chip has significant advantages in various aspects such as performance, cost, power consumption, reliability, life cycle and service scope. In addition, in other embodiments of the present application, the sub-circuits of the battery protection circuit 100 except for the first switch sub-circuit 180 are fabricated on the same chip, i.e., the sub-circuits of the battery protection circuit 100 except for the first switch sub-circuit 180 as a whole is fabricated as a system-on-chip. In some other embodiments, the second resistor R2 and capacitor C in FIG. 3 may also be included in the on-chip system.

It should be understood that the term “multiple” mentioned inhere refers to two or more. Other embodiments of the present application will be readily appreciated by those skilled in the art upon consideration of the specification and practice of the application disclosed herein. This application is intended to cover any variation, use, or adaptive modifications of the present application that follows the general principles of the present application and includes commonly known or customary technical means in the art that are not disclosed herein. The specification and embodiments are deemed to be of an exemplary nature only, and the scope and spirit of the present application are indicated by the claims below.

It should be noted that each embodiment in this specification is described in a progressive manner, each embodiment is focused on what is different from the other embodiments, and for the same or similar parts between the various embodiments, references may be made to each other. For device embodiments, which are basically similar to method embodiments, the description is relatively simple, and the relevant parts can be found in the description of the method embodiment.

The above disclosure is merely some optional embodiments of the present application, which shall not be considered as limitation to the scope of the claims of the present application, so equivalent variations made in accordance with the claims of the present application, shall all be included within the protection scope of the present application.

What is claimed is:

1. A battery protection circuit, comprising: a power supply terminal, a power ground terminal, an overcharge voltage protection sub-circuit, an over-discharge voltage protection sub-circuit, a discharge over-current protection sub-circuit, a reference voltage generation sub-circuit, a frequency generation sub-circuit, a controller and a first switch sub-circuit;
wherein the power supply terminal and power ground terminal are respectively configured to be electrically connected to a battery, the controller is respectively connected to the overcharge voltage protection sub-circuit, the over-discharge voltage protection sub-circuit, the discharge over-current protection sub-circuit, the frequency generation sub-circuit and the first switch sub-circuit, the battery protection circuit is configured to provide an overcharge protection, an over-discharge protection, and an over-current protection for the battery, the first switch sub-circuit is configured to control the battery to supply power to a system circuit;
wherein the battery protection circuit further comprises a shipping input terminal, the battery protection circuit is configured to enter a shipping mode when a first signal is received at the shipping input terminal, and at least one sub-circuit of the battery protection circuit is powered off in the shipping mode; and
wherein the first switch sub-circuit is switched off in the shipping mode, to enable the battery to stop supplying power to the system circuit.

2. The battery protection circuit according to claim 1, wherein the battery protection circuit further comprises a wake-up sub-circuit, the wake-up sub-circuit is powered on in the shipping mode, and the wake-up sub-circuit is configured to enable the battery protection circuit to exit the shipping mode.

3. The battery protection circuit according to claim 1, wherein the battery protection circuit is triggered to generate a shipping control signal to enter the shipping mode when the first signal is received at the shipping input terminal.

4. The battery protection circuit according to claim 3, wherein the first signal is a coded signal based on a protocol between the battery protection circuit and the system circuit.

5. The battery protection circuit according to claim 4, wherein the first signal comprises a pulse signal, the battery protection circuit further comprises a pulse counting sub-circuit, the pulse counting sub-circuit is in electrical connection with the shipping input terminal, and a generation of the shipping control signal is triggered when a number of pulses received by the pulse counting sub-circuit within a first predetermined time period is greater than or equal to a first predetermined number.

6. The battery protection circuit according to claim 3, wherein the first signal comprises a continuous high-level signal or a continuous low-level signal, the battery protection circuit further comprises a first timing sub-circuit, the first timing sub-circuit is in electrical connection with the shipping input terminal, and a generation of the shipping control signal is triggered when a duration of the high-level signal or the low-level signal received by the first timing sub-circuit is greater than or equal to a second predetermined time period.

7. The battery protection circuit according to claim 3, wherein the over-discharge voltage protection sub-circuit is further in electrical connection with the shipping input terminal,
the over-discharge voltage protection sub-circuit comprises a comparator and a second timing sub-circuit, an output of the comparator is in electrical connection with the second timing sub-circuit, the first signal is a continuous high-level signal or a continuous low-level signal,
the battery protection circuit further comprises a second switch sub-circuit and a first resistor, a control end of the second switch sub-circuit is in electrical connection with the shipping input terminal, an input of the second switch sub-circuit is grounded, an output of the second switch sub-circuit is in electrical connection with one end of the first resistor, and another end of the first resistor is connected to a high level, the output of the second switch sub-circuit is further electrically connected to an inverting terminal of the comparator of the over-discharge voltage protection sub-circuit,
the inverting terminal of the comparator is further electrically connected with an output voltage detection point of the battery, a non-inverting terminal of the comparator is connected with a reference voltage, an output of the comparator is in electrical connection with a second timing sub-circuit, the second switch sub-circuit is switched on, when the first signal is received at the shipping input terminal, a voltage at the non-inverting terminal of the comparator is greater than a voltage at the inverting terminal, a high level is output from the comparator, and when a duration of the high level received by the second timing sub-circuit is greater than or equal to a third predetermined time period, a generation of the shipping control signal is triggered.

8. The battery protection circuit according to claim 1, wherein the battery protection circuit further comprises a wake-up sub-circuit, and the wake-up sub-circuit is the charge detection sub-circuit.

9. The battery protection circuit according to claim 8, wherein the battery protection circuit is enabled to exit the shipping mode when a charging signal is detected by the charge detection sub-circuit.

10. The battery protection circuit according to claim 1, wherein at least one or all of the overcharge voltage protection sub-circuit, the over-discharge voltage protection sub-circuit, the discharge over-current protection sub-circuit, the controller, the reference voltage generation sub-circuit and the frequency generation sub-circuit are powered off in the shipping mode;
the battery protection circuit further comprises a second switch sub-circuit and a first resistor, a control end of the second switch sub-circuit is in electrical connection with the shipping input terminal, an output of the second switch sub-circuit is in electrical connection with one end of the first resistor, another end of the first resistor is connected to a high level,
the second switch sub-circuit is switched on, when a first signal is received at the shipping input terminal, the output of the second switch sub-circuit is at a low level, the battery protection circuit performs the over-discharge protection so as to be enable to enter the shipping mode, the first switch sub-circuit is remained at a switched-off state in the shipping mode.

11. The battery protection circuit according to claim 10, wherein all sub-circuits of the battery protection circuit except for the wake-up sub-circuit are powered off when the battery protection circuit is in the shipping mode.

12. The battery protection circuit according to claim 1, wherein the first switch sub-circuit comprises a MOS transistor;
an over-discharge protection signal is generated by the over-discharge voltage protection sub-circuit to trigger the over-discharge protection for the battery protection circuit, when the first signal is received at the shipping input terminal, to enable the battery protection circuit to enter the shipping mode, and the first switch sub-circuit is remained at a switched-off state in the shipping mode;
or alternatively, the over-discharge protection signal is generated by the over-discharge voltage protection sub-circuit, and the over-discharge protection for the battery protection circuit is triggered by the controller, when the first signal is received at the shipping input terminal and a duration of the first signal is greater than or equal to a third predetermined time period, to enable the battery protection circuit to enter the shipping mode, and the first switch sub-circuit is remained at a switched-off state in the shipping mode.

13. The battery protection circuit according to claim 1, wherein the battery protection circuit is fabricated on a same chip, or alternatively, all sub-circuits of the battery protection circuit except for the first switch sub-circuit are fabricated on the same chip, the shipping input terminal is a shipping input pin, the power supply terminal is a power supply pin, and the power ground terminal is a power ground pin;
the battery protection circuit is triggered to generate a shipping control signal to enter the shipping mode when the first signal is received at the shipping input terminal, the shipping control signal is output to the overcharge voltage protection sub-circuit, the over-discharge voltage protection sub-circuit, the discharge over-current protection sub-circuit, the reference voltage generation sub-circuit, the frequency generation sub-circuit and the controller, to block these sub-circuits from being powered.

14. A battery pack, comprising:
a battery; and
the battery protection circuit of claim 1,
wherein the power supply terminal and the power ground terminal of the battery protection circuit are electrically connected to the battery, respectively.

15. The battery pack according to claim 14, wherein the battery has a capacity in a range from 10 mAH to 80 mAH.

16. An electronic device, comprising:
the battery pack of claim 14; and
a system circuit,
wherein the battery is controlled to supply power to the system circuit via the battery protection circuit.

17. The electronic device according to claim 16, wherein the battery protection circuit is triggered to generate a shipping control signal to enter the shipping mode when the first signal is received at the shipping input terminal, the over-discharge voltage protection sub-circuit is further in electrical connection with the shipping input terminal,
the over-discharge voltage protection sub-circuit comprises a comparator and a second timing sub-circuit, an output of the comparator is in electrical connection with the second timing sub-circuit, the first signal is a continuous high-level signal or a continuous low-level signal,
the battery protection circuit further comprises a second switch sub-circuit and a first resistor, a control end of the second switch sub-circuit is in electrical connection with the shipping input terminal, an input of the second switch sub-circuit is grounded, an output of the second switch sub-circuit is in electrical connection with one end of the first resistor, and another end of the first resistor is connected to a high level, the output of the second switch sub-circuit is further electrically connected to an inverting terminal of the comparator of the over-discharge voltage protection sub-circuit,
the inverting terminal of the comparator is further electrically connected with an output voltage detection point of the battery, a non-inverting terminal of the comparator is connected with a reference voltage, an output of the comparator is in electrical connection with a second timing sub-circuit, the second switch sub-circuit is switched on, when the first signal is received at the shipping input terminal, a voltage at the non-inverting terminal of the comparator is greater than a voltage at the inverting terminal, a high level is output from the comparator, and when a duration of the high level received by the second timing sub-circuit is greater than or equal to a third predetermined time period, a generation of the shipping control signal is triggered.

18. The electronic device according to claim 16, wherein at least one or all of the overcharge voltage protection sub-circuit, the over-discharge voltage protection sub-circuit, the discharge over-current protection sub-circuit, the controller, the reference voltage generation sub-circuit and the frequency generation sub-circuit are powered off in the shipping mode;
the battery protection circuit further comprises a second switch sub-circuit and a first resistor, a control end of the second switch sub-circuit is in electrical connection with the shipping input terminal, an output of the second switch sub-circuit is in electrical connection with one end of the first resistor, another end of the first resistor is connected to a high level, the second switch sub-circuit is switched on, when a first signal is received at the shipping input terminal, the output of the second switch sub-circuit is at a low level, the battery protection circuit performs the over-discharge protection so as to be enable to enter the shipping mode, the first switch sub-circuit is remained at a switched-off state in the shipping mode.

19. The electronic device according to claim 16, wherein an over-discharge protection signal is generated by the over-discharge voltage protection sub-circuit to trigger the over-discharge protection for the battery protection circuit, when the first signal is received at the shipping input terminal, to enable the battery protection circuit to enter the shipping mode, and the first switch sub-circuit is remained at a switched-off state in the shipping mode;
or alternatively, the over-discharge protection signal is generated by the over-discharge voltage protection sub-circuit, and the over-discharge protection for the battery protection circuit is triggered by the controller, when the first signal is received at the shipping input terminal and a duration of the first signal is greater than or equal to a third predetermined time period, to enable the battery protection circuit to enter the shipping mode, and the first switch sub-circuit is remained at a switched-off state in the shipping mode.

20. The electronic device according to claim 16, wherein the battery protection circuit is fabricated on a same chip, or alternatively, all sub-circuits of the battery protection circuit except for the first switch sub-circuit are fabricated on the same chip, the shipping input terminal is a shipping input pin, the power supply terminal is a power supply pin, and the power ground terminal is a power ground pin; and
the battery protection circuit is triggered to generate a shipping control signal to enter the shipping mode when the first signal is received at the shipping input terminal, the shipping control signal is output to the overcharge voltage protection sub-circuit, the over-discharge voltage protection sub-circuit, the discharge over-current protection sub-circuit, the reference voltage generation sub-circuit, the frequency generation sub-circuit and the controller, to block these sub-circuits from being powered.
